(19) United States
(12) Patent Application Publication
(10) Pub. No.: US 2025/0373021 A1
(43) Pub. Date: Dec. 4, 2025

(54) Intelligent Control System and Method for Distributed Photovoltaic Power Generation Cluster

(71) Applicant: Guizhou Power Grid Co., Ltd., Guiyang (CN)

(72) Inventors: Yu ZHANG, Guiyang (CN); Libo ZHANG, Guiyang (CN); Xueyong TANG, Guiyang (CN); Xin HE, Guiyang (CN); Julong CHEN, Guiyang (CN); Zhen LI, Guiyang (CN); Qingsheng LI, Guiyang (CN); Zhaofeng ZHANG, Guiyang (CN); Bin WANG, Guiyang (CN); Chen LUO, Guiyang (CN)

(21) Appl. No.: 19/008,065

(22) Filed: Jan. 2, 2025

Related U.S. Application Data
(63) Continuation of application No. PCT/CN2024/135923, filed on Nov. 29, 2024.

(30) Foreign Application Priority Data
May 29, 2024 (CN) 202410678926X

(51) Int. Cl. H02J 3/38; H02J 3/00; H02S 50/10

(52) U.S. Cl. CPC H02J 3/38; H02J 3/0012; H02S 50/10; H02J 2300/26

(57) ABSTRACT

The present invention discloses an intelligent control system for a distributed photovoltaic power generation cluster, and relate to the field of distributed energy technologies. The intelligent control system includes: a data acquisition module, used for acquiring demand basic data, supply basic data, and fault basic data respectively to form control basic data; a data analysis module, used for analyzing the control basic data to obtain control analysis data; a data processing module, used for processing the control analysis data to obtain a supply and demand balance reference value; and an intelligent control module, used for intelligently controlling the photovoltaic power generation cluster according to the supply and demand balance reference value.

### CROSS-REFERENCE TO RELATED APPLICATIONS

The present application claims priority to Chinese Patent Application No. 202410678926X, filed on May 29, 2024, the entire disclosure of which is incorporated herein by reference.

### TECHNICAL FIELD

The present invention relates to the field of distributed power technologies, and in particular to an intelligent control system and method for a distributed photovoltaic power generation cluster.

### BACKGROUND

A distributed photovoltaic power generation cluster refers to integrating and networking a plurality of photovoltaic power generation systems, and converting solar energy to electric energy through distributed power generation. This cluster includes various forms such as a rooftop photovoltaic power generation system and a ground photovoltaic power station. Through clustering, it can achieve cooperative work between the photovoltaic power generation systems, improve overall power generation efficiency, reduce an energy loss, and better cope with a grid fluctuation and a demand change.

In the prior art, there are the following defects in controlling the distributed photovoltaic power generation cluster: real-time specific values of a demand and a supply of the power generation cluster cannot be obtained, and it lacks pertinence to control, resulting in low utilization efficiency of electric energy resources; it is difficult to monitor a faulty solar panel in the power generation cluster in real time, and difficult to accurately acquire an area value of the faulty solar panel in real time; and it is difficult to judge the supply and the demand of the photovoltaic power generation cluster according to the area value of the faulty solar panel, and a generated power of photovoltaic power generation cluster cannot be accurately controlled.

For this purpose, an intelligent control system for a distributed photovoltaic power generation cluster is proposed.

### SUMMARY

In view of the existing problems mentioned above, the present invention is proposed.

Therefore, the present invention provides an intelligent control system for a distributed photovoltaic power generation cluster. In order to achieve the above purpose, the present invention acquires and analyzes control basic data to obtain an electricity demand, a theoretical power generation supply, and real-time fault data, defines them as control analysis data, obtains a supply and demand balance reference value by processing the control analysis data, and intelligently controls the photovoltaic power generation cluster according to the supply and demand balance reference value.

To solve the above technical problems, the present invention provides the following technical solution: the intelligent control system for the distributed photovoltaic power generation cluster includes a data acquisition module, used for acquiring demand basic data, supply basic data, and fault basic data respectively to comprehensively obtain control basic data;
a data analysis module, used for analyzing the control basic data to obtain an electricity demand, a theoretical power generation supply, and real-time fault data, and defining them as control analysis data;
a data processing module, used for processing the control analysis data to obtain a supply and demand balance reference value; and
an intelligent control module, used for intelligently controlling the photovoltaic power generation cluster according to the supply and demand balance reference value.

As a preferred solution of the intelligent control system for the distributed photovoltaic power generation cluster of the present invention, the data acquisition module includes: data stored in a database, including an electricity consumption unit amount in a corresponding power supply region of the photovoltaic power generation cluster and an area value of a corresponding power generation panel of the photovoltaic power generation cluster;
the data acquisition module comprises a demand unit, a supply unit, and a fault unit;
the demand unit acquires the demand basic data, specifically, acquires the electricity consumption unit amount in the corresponding power supply region of the photovoltaic power generation cluster and the area value of the corresponding power generation panel of the photovoltaic power generation cluster through the database, selects m electricity consumption units as sample electricity consumption units, acquires daily benchmark electricity consumptions of the sample power consumption units through a smart meter respectively, and calculates an average daily benchmark electricity consumption of the electricity consumption units based on the daily benchmark electricity consumptions of the sample electricity consumption units:

$$Jp = \frac{J 1 + J 2 + J 3 + … … + Jm}{m}$$

where Jp is the average daily benchmark electricity consumption of the electricity consumption units, and J1, J2, J3 . . . Jm are the daily benchmark electricity consumptions of the m sample electricity consumption units respectively.

n characteristic time points are selected, and temperature values of the n characteristic time points are acquired by a weather forecast respectively, and a daily average temperature value is calculated from the temperature values of the n characteristic time points through an average temperature calculation formula:

$$Tp = \frac{T 1 + T 2 + … … + Tn}{n}$$

where T1, T2, T3 . . . Tn are the temperature values of the n characteristic time points respectively, Tp is the daily average temperature value, and n is larger than 0.

The average daily benchmark electricity consumption of the electricity consumption units, the electricity consumption unit amount, and the daily average temperature value are defined as the demand basic data.

the supply unit acquires the supply basic data, acquires the area value of the power generation panel of the power generation cluster through the database, randomly selects p solar panels from the photovoltaic power generation cluster as characteristic solar panels, acquires real-time generated powers of the characteristic solar panels through an electric power sensor respectively, acquires area values of the characteristic solar panels through an area measurement instrument respectively, and calculates an average generated power value per unit area of the solar panels from the real-time generated powers of the characteristic solar panels and the area values of the characteristic solar panels through a calculation formula of a generated power per unit area:

$$Dw = \frac{\frac{W 1}{S 1} + \frac{W 2}{S 2} + \frac{W 3}{S 3} + … … + \frac{Wp}{Sp}}{p}$$

where W1, W2, W3 . . . Wp are the real-time generated powers of the characteristic solar panels respectively, S1, S2, S3 . . . Sn are area values of the characteristic solar panels respectively, and p is a value of a number of the selected characteristic solar panels and is larger than 0.

single-day power generation duration values of the characteristic solar panels are acquired respectively, and a time-of-day average power generation duration value of the solar panels is calculated from the single-day power generation duration values of the characteristic solar panels:

$$Scj = \frac{Sc 1 + Sc 2 + Sc 3 + … … + Scp}{p}$$

where Scj is the time-of-day average power generation duration value of the solar panels, Sc1, Sc2, Sc3 . . . Scp are the single-day power generation duration values of the characteristic solar panels respectively, and p is the value of the number of the selected characteristic solar panels and is larger than 0.

The area value of the power generation panel of the power generation cluster, the average generated power value per unit area of the solar panels, and the time-of-day average power generation duration value of the solar panels are defined as the supply basic data.

The fault unit acquires the fault basic data, specifically, acquires an open circuit voltage value of each solar panel of the photovoltaic power generation cluster in real time through a voltage sensor, acquires a short circuit current value of each solar panel of the photovoltaic power generation cluster in real time through a current sensor, acquires a surface real-time temperature value of each solar panel of the photovoltaic power generation cluster through a temperature sensor respectively, and defines the open circuit voltage value, the short circuit current value, and the surface real-time temperature value of each solar panel as the fault basic data.

the demand basic data, the supply basic data, and the fault basic data are defined as the control basic data, and the data acquisition module acquires the control basic data.

As a preferred solution of the intelligent control system for the distributed photovoltaic power generation cluster of the present invention, the data analysis module includes obtaining the control analysis data by analyzing the control basic data, and includes a demand analysis unit, a supply analysis unit, and a fault analysis unit.

The data stored in the database further includes an open circuit benchmark voltage value, a short circuit benchmark current value, and a surface benchmark temperature value of the solar panel, and an open circuit voltage fault error value, a short circuit current fault error value, and a surface temperature fault error value of the solar panel.

the demand analysis unit analyzes the demand basic data, specifically, acquires the average daily benchmark electricity consumption of the electricity consumption units, the electricity consumption unit amount, and the daily average temperature value according to the demand basic data, and calculates the electricity demand from the average daily benchmark electricity consumption of the electricity consumption units, the electricity consumption unit amount, and the daily average temperature value through an electricity demand calculation formula:

$$Xd = Jp ⋆ Ds ⋆ 1 + \vert Tp - 25 \vert$$

where Xd is the electricity demand, Jp is the average daily benchmark electricity consumption of the electricity consumption units, Ds is the electricity consumption unit amount, and Tp is the daily average temperature value.

the supply analysis unit analyzes the supply basic data, acquires the area value of the power generation panel of the power generation cluster, the average generated power value per unit area of the solar panels, and the time-of-day average power generation duration value of the solar panels according to the supply basic data, and calculates the theoretical power generation supply from the area value of the power generation panel of the power generation cluster, the average generated power value per unit area of the solar panels, and the time-of-day average power generation duration value of the solar panels:

$$Fd = Mj ⋆ Dw ⋆ Scj$$

where Fd is the theoretical power generation supply, Mj is the area value of the power generation panel of the power generation cluster, Dw is the average generated power value per unit area of the solar panels, and Scj is the time-of-day average power generation duration value of the solar panels.

The fault analysis unit analyzes the fault basic data to obtain real-time fault data.

the electricity demand, the theoretical power generation supply, and the real-time fault data are defined as the control analysis data, and the data analysis module acquires the control analysis data.

As a preferred solution of the intelligent control system for the distributed photovoltaic power generation cluster of the present invention, the analyzing the fault basic data by the fault analysis unit includes: acquiring the open circuit voltage value, the short circuit current value, and the surface real-time temperature value of each solar panel according to the fault basic data;
acquiring the open circuit benchmark voltage value, the short circuit benchmark current value, and the surface benchmark temperature value of the solar panel according to the database;
calculating a fault judgment reference value of the solar panel from the open circuit voltage value, the short circuit current value, and the surface real-time temperature value of the solar panel, and the open circuit benchmark voltage value, the short circuit benchmark current value, and the surface benchmark temperature value of the solar panel,

$$Tp = \vert Vk - Vkj \vert ⋆ \vert Id - Idj \vert + \vert Bw - Bwj \vert ⋆ a 1$$

wherein Tp is the fault judgment reference value of the solar panel, Vk is the open circuit voltage value, Id is the short circuit current value, Bw is the surface real-time temperature value, Vkj is the open circuit benchmark voltage value, the Idj is the short circuit benchmark current value, Bwj is the surface benchmark temperature value, and a1 is a set proportionality coefficient and is larger than 0;
acquiring the open circuit voltage fault error value, the short circuit current fault error value, and the surface temperature fault error value of the solar panel through the database respectively, and calculating a fault judgment reference threshold of the solar panel from the open circuit voltage fault error value, the short circuit current fault error value, and the surface temperature fault error value of the solar panel for fault judgment on the solar panel:

$$Tp 1 = Vk 1 ⋆ Id 1 - Bw 1 ⋆ a 1$$

where Tp1 is the fault judgment reference threshold of the solar panel, Vk1 is the open circuit voltage fault error value, Id1 is the short circuit current fault error value, Bw1 is the surface temperature fault error value, and a1 is the set proportionality coefficient and is larger than 0;
judging the solar panel as a faulty solar panel if Tp≥Tp1;
judging the solar panel as a normal solar panel if Tp1>Tp;
obtaining a real-time area value of the faulty solar panel through real-time area statistics on the normal solar panel; and
defining the real-time area value of the faulty solar panel as the real-time fault data.

As a preferred solution of the intelligent control system for the distributed photovoltaic power generation cluster of the present invention, the data processing module includes: obtaining supply and demand control data by processing the control analysis data, and the data processing module acquires the electricity demand, the theoretical power generation supply, and the real-time fault data according to the control analysis data.

The data processing module includes a supply processing unit and a supply and demand balancing unit.

The supply processing unit acquires an actual power generation supply, specifically, acquires the theoretical power generation supply according to the control analysis data, acquires a real-time area value of the faulty solar panel according to the real-time fault data, and acquires the average generated power value per unit area of the solar panels and the time-of-day average power generation duration value of the solar panels according to the control basic data,
calculates the actual power generation supply from the theoretical power generation supply, the real-time area value of the faulty solar panel, the average generated power value per unit area of the solar panels, and the time-of-day average power generation duration value of the solar panels through an actual power generation supply calculation formula:

$$Sg = Fd - ( Gb ⋆ Dw ⋆ Scj )$$

where Sg is the actual power generation supply, Fd is the theoretical power generation supply, Dw is the average generated power value per unit area of the solar panels, Scj is the time-of-day average power generation duration value of the solar panels, and Gb is the real-time area value of the faulty solar panel.

the supply and demand balancing unit acquires the supply and demand balance reference value, specifically, acquires the actual power generation supply and the electricity demand respectively, and calculates the supply and demand balance reference value from the actual power generation supply and the electricity demand through a supply and demand balance reference value calculation formula:

$$Ph = \frac{Xd}{Sg}$$

where Ph is the supply and demand balance reference value, Xd is the electricity demand, and Sg is the actual power generation supply.

the data processing module acquires the supply and demand balance reference value, and transmits the supply and demand balance reference value to the intelligent control module.

As a preferred solution of the intelligent control system for the distributed photovoltaic power generation cluster of the present invention, the intelligent control module includes: setting a first control interval in response to the supply and demand balance reference value Ph larger than 1 and the electricity demand larger than the actual power generation supply at this time;
setting a second control interval in response to the supply and demand balance reference value Ph equal to 1 and the electricity demand equal to the actual power generation supply at this time; and
setting a third control interval in response to the supply and demand balance reference value Ph smaller than 1 and the electricity demand smaller than the actual power generation supply at this time.

Aiming to the first control interval, the intelligent control system is switched to an efficient working mode, the photovoltaic power generation cluster increases a generated power of the photovoltaic power generation cluster through a cooperative control system, temporarily supplies stored electric energy to an electricity consumption unit, increases an inclination angle of a photovoltaic cell panel, increases a reception quantity of solar radiation, improves power generation efficiency of a photovoltaic cell, and optimizes a working point of the photovoltaic cell through a maximum power point tracking algorithm, to increase a generated power of a single working point.

Aiming to the second control interval, the photovoltaic power generation cluster maintains the current generated power of the photovoltaic power generation cluster through the cooperative control system.

aiming to the third control interval, the intelligent control system is switched to a low power consumption working mode, the photovoltaic power generation cluster lowers the generated power of the photovoltaic power generation cluster through the cooperative control system, stores excess electric energy, reduces the inclination angle of the photovoltaic cell panel and a reception area of solar radiation, and lowers the generated power.

Another purpose of the present invention is to provide an intelligent control method for a distributed photovoltaic power generation cluster, which improves overall performance and economic benefit of the photovoltaic power generation system through intelligent management and control. Specifically, it aims to adjust the working point of the photovoltaic cell panel to the maximum power point by monitoring and analyzing an operating state and an environmental condition of the photovoltaic panel in real time, so as to maximize the generated power of each cell panel. Meanwhile, the system automatically adjusts an output of the photovoltaic power generation cluster according to a real-time demand and a power generation capacity, to ensure supply and demand balance and reduce energy waste. In addition, through real-time monitoring and analysis of fault data, the intelligent control system can discover and deal with potential problems timely, can reduce system failure and downtime to make the distributed photovoltaic power generation system more efficient, stable and reliable, and can be automatically adjusted under different environmental and demand conditions to achieve the best power generation effect and economic benefits and promote sustainable development at the same time.

As a preferred solution of a method using the intelligent control system for the distributed photovoltaic power generation cluster of the present invention, the method includes: acquiring the control basic data;
obtaining the control analysis data by analyzing the control basic data;
obtaining the supply and demand balance reference value by processing the control analysis data; and
intelligently controlling the photovoltaic power generation cluster according to the supply and demand balance reference value, and optimizing the working point of the photovoltaic cell through the maximum power point tracking algorithm.

As a preferred solution of the intelligent control method for the distributed photovoltaic power generation cluster of the present invention, the maximum power point tracking algorithm includes: optimizing the working point of the photovoltaic cell, with a specific model as follows:

$${P}_{opt} = {\int }_{{θ}_{min}}^{{θ}_{max}} ( {I}_{s c} \cdot ( 1 - exp ( - \frac{{1}_{pgc}}{{1}_{S C}} ) \cdot \frac{{P}_{mpp} ( θ )}{{\sum }_{i = 1}^{N} {P}_{mpp , i} ( θ )} ) d θ$$

wherein Pₒₚₜ is a maximum generated power of the photovoltaic cell panel subjected to optimization with the maximum power point tracking algorithm, θₘᵢₙ and θₘₐₓ are a maximum value and a minimum value of the inclination angle of the cell panel respectively, I_{SC} is a short circuit current of the cell panel, I_{pgc} is a photogenerated current, Pₘₚₚ(θ) is a power at a maximum power point in a case of the inclination angle being θ, N is a total amount of the photovoltaic cell panels, and P_{mpp,i}(θ) is a power at a maximum power point of the ith cell panel in a case of the inclination angle being θ;
if Pₒₚₜ is close to a maximum value of Pₘₚₚ(θ), the photovoltaic cell panel achieves an optimal power generation state after optimization with the maximum power point tracking algorithm; if Pₒₚₜ is close to 0, the power generation efficiency of the photovoltaic cell panel is very low, which is due to an improper inclination angle of the cell panel; a proper inclination angle of the cell panel is calculated with consideration of influences of the inclination angle and an azimuth angle on the power generation efficiency:

$${α}_{opt} ( t ) = arctan ( \frac{sin ( θ ( t ) )}{cos ( θ ( t ) ) \times sin ( β - φ ( t ) )} )$$

an output power of the maximum power point tracking (MPPT) algorithm with consideration of influences of the MPPT algorithm on the power generation efficiency is expressed as follows:

$${f}_{MPPT} ( {P}_{PV} ) = {P}_{PV} \times ( 1 - exp ( - \frac{{P}_{PV}}{{P}_{PV , max}} ) )$$

$${P}_{PV} ( t ) = {I}_{PV} ( t ) \times {V}_{PV} ( t )$$

the proper inclination angle of the cell panel is calculated after optimization:

$${P}_{PV , opt} ( t ) = {f}_{MPPT} ( {I}_{PV} ( t ) \times {V}_{PV} ( t ) )$$

$${α}_{opt} ( t ) = \frac{{\int }_{0}^{24} {P}_{PV , opt} ( t ) d t}{{\int }_{0}^{24} G ( t ) d t}$$

Wherein I_{PV}(t) represents a current of the photovoltaic cell panel at time t, V_{PV}(t) represents a voltage of the photovoltaic cell panel at time t, P_{PV}(t) represents a power of the photovoltaic cell panel at time t, αₒₚₜ represents an inclination angle between the photovoltaic cell panel and the ground, β represents the azimuth angle of the photovoltaic cell panel, θ(t) represents an altitude angle of the sun, φ(t) represents an azimuth angle of the sun, G(t) represents solar radiation intensity, f_{MPPT}(P_{PV}) represents the output power of the maximum power point tracking algorithm, and P_{PV,max} is the power of the photovoltaic cell panel at the maximum power point.

An electronic device includes a memory, a processor, and a computer program stored on the memory, where when the computer program is executed by the processor, the steps of the intelligent control method for the distributed photovoltaic power generation cluster are implemented.

A computer-readable storage medium in which a computer program is stored, where when the computer program is executed by a processor, the steps of the intelligent control method for the distributed photovoltaic power generation cluster are implemented.

The present invention has the beneficial effects that: the present invention monitors a fault of the solar panel in the power generation cluster in real time by accurately acquiring the area value of the faulty solar panel in real time, and precisely controls the generated power of the photovoltaic power generation cluster by judging the supply and the demand of the photovoltaic power generation cluster according to the area value of the faulty solar panel.

### BRIEF DESCRIPTION OF DRAWINGS

To more clearly describe the technical solutions of the embodiments of the present invention, the accompanying drawings required to describe the embodiments are briefly described below. Apparently, the accompanying drawings described below are only some embodiments of the present invention. Those skilled in the art may further obtain Other drawings based on these accompanying drawings without inventive effort. In the drawings:

FIG. 1 is a block flowchart of an intelligent control system for a distributed photovoltaic power generation cluster provided by an embodiment of the present invention;

FIG. 2 is a working schematic diagram of a solar panel of an intelligent control system for a distributed photovoltaic power generation cluster provided by an embodiment of the present invention; and

FIG. 3 is an overall flowchart of an intelligent control method for a distributed photovoltaic power generation cluster provided by an embodiment of the present invention.

### DETAILED DESCRIPTION OF THE EMBODIMENTS

In order to make the aforementioned purposes, features and advantages of the present invention more apparent and comprehensible, detailed descriptions of specific embodiments of the present invention are provided below in conjunction with the appended drawings. It is understood that the described embodiments are merely a part of the embodiments of the present invention, rather than all embodiments. Based on the embodiments of the present invention, all other embodiments obtained by those of ordinary skill in the art without creative efforts shall fall within the protection scope of the present invention.

A number of specific details are set forth in the description below to provide a thorough understanding for the present invention, however, the present invention may also be implemented in other manners different from those described herein, and those skilled in the art may make similar generalization without departing from the essence of the present invention; and therefore, the present invention is not limited by the specific embodiments disclosed below.

Secondly, the term “one embodiment” or “embodiments” referred herein refers to specific features, structures, or characteristics that may be incorporated into at least one realization manner of the present invention. The term “one embodiment” appearing in different places in the present specification does not necessarily refer to the same embodiment, nor is it a separate or selective embodiment that is mutually exclusive with other embodiments.

The present invention is described in detail in conjunction with schematic diagrams. For the purpose of description, sectional views of the device structure are partially enlarged without being drawn to scale. The schematic diagrams are merely exemplary and should not limit the protection scope of the present invention. Furthermore, is it important to consider the three-dimensional spatial dimensions of length, width, and depth in actual production.

It should be noted that in the description of the present invention that terms such as “up, down, inside, and outside” indicating orientation or positional relationships are based on the orientation or positional relationships shown in the illustrations for the purpose of facilitating the description and simplifying the disclosure. They do not indicate or imply that the device or the components referred to must have a specific orientation, be constructed in a specific orientation, or operate in a specific orientation, and therefore should not be construed as limiting the present invention. Moreover, terms like “first, second or third” are only used for description, and should not be considered as a designation or designation of relative importance.

Unless otherwise explicitly specified and limited in the present invention, the terms “installation, connection, and linking” should be understood in a broad sense. For example, they could refer to fixed or detachable connections, as well as integrally formed connections. They could also encompass mechanical, electrical or direct connections, indirect connections via intermediaries, and connections within two components. The terms described above have specific meanings in the present invention that can be understood by those skilled in the art in light of the particular circumstances.

### Embodiment 1

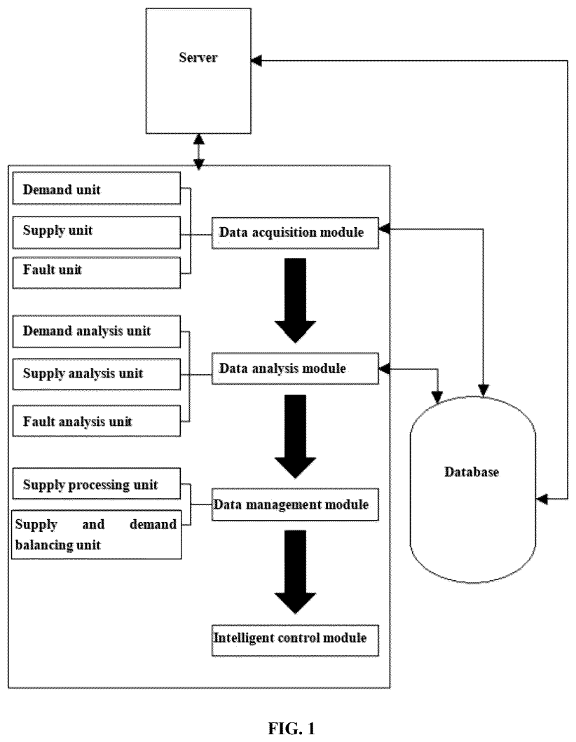

Referring to FIG. 1, showing a first embodiment of the present invention, the embodiment provides an intelligent control system for a distributed photovoltaic power generation cluster, including a data acquisition module, used for acquiring demand basic data, supply basic data, and fault basic data respectively to comprehensively obtain control basic data;
a data analysis module, used for analyzing the control basic data to obtain an electricity demand, a theoretical power generation supply, and real-time fault data, and defining them as control analysis data;
a data processing module, used for processing the control analysis data to obtain a supply and demand balance reference value; and
an intelligent control module, used for intelligently controlling the photovoltaic power generation cluster according to the supply and demand balance reference value.

Preferably, the data acquisition module, the data analysis module, the data processing module, and the intelligent control module are connected to a server respectively.

It is to be noted that the data acquisition module includes: data stored in a database, including an electricity consumption unit amount in a corresponding power supply region of the photovoltaic power generation cluster and an area value of a corresponding power generation panel of the photovoltaic power generation cluster;
the data acquisition module comprises a demand unit, a supply unit, and a fault unit;
the demand unit acquires the demand basic data, specifically, acquires the electricity consumption unit amount in the corresponding power supply region of the photovoltaic power generation cluster and the area value of the corresponding power generation panel of the photovoltaic power generation cluster through the database, selects m electricity consumption units as sample electricity consumption daily units, acquires benchmark electricity consumptions of the sample power consumption units through a smart meter respectively, and calculates an average daily benchmark electricity consumption of the electricity consumption units based on the daily benchmark electricity consumptions of the sample electricity consumption units:

$$Jp = \frac{J 1 + J 2 + J 3 + … + Jm}{m}$$

where Jp is the average daily benchmark electricity consumption of the electricity consumption units, and J1, J2, J3 . . . Jm are the daily benchmark electricity consumptions of the m sample electricity consumption units respectively.

n characteristic time points are selected, and temperature values of the n characteristic time points are acquired by a weather forecast respectively, and a daily average temperature value is calculated from the temperature values of the n characteristic time points through an average temperature calculation formula:

$$Tp = \frac{T 1 + T 2 + … + Tn}{n}$$

where T1, T2, T3 . . . Tn are the temperature values of the n characteristic time points respectively, Tp is the daily average temperature value, and n is larger than 0.

The average daily benchmark electricity consumption of the electricity consumption units, the electricity consumption unit amount, and the daily average temperature value are defined as the demand basic data.

It is to be noted here that the daily benchmark electricity consumption refers to a normal power consumption of a certain electricity consumption unit within a specific time period (usually one day); and the sample power electricity units involve different electricity consumption units such as hospitals, shopping malls, and communities.

the supply unit acquires the supply basic data, acquires the area value of the power generation panel of the power generation cluster through the database, randomly selects p solar panels from the photovoltaic power generation cluster as characteristic solar panels, acquires real-time generated powers of the characteristic solar panels through an electric power sensor respectively, acquires area values of the characteristic solar panels through an area measurement instrument respectively, and calculates an average generated power value per unit area of the solar panels from the real-time generated powers of the characteristic solar panels and the area values of the characteristic solar panels through a calculation formula of a generated power per unit area:

$$Dw = \frac{\frac{W 1}{S 1} + \frac{W 2}{S 2} + \frac{W 3}{S 3} + … + \frac{Wp}{Sp}}{p}$$

where W1, W2, W3 . . . Wp are the real-time generated powers of the characteristic solar panels respectively, S1, S2, S3 . . . Sn are area values of the characteristic solar panels respectively, and p is a value of a number of the selected characteristic solar panels and is larger than 0.

It is to be noted here that the unit area involved here is specifically set as 1 m2.

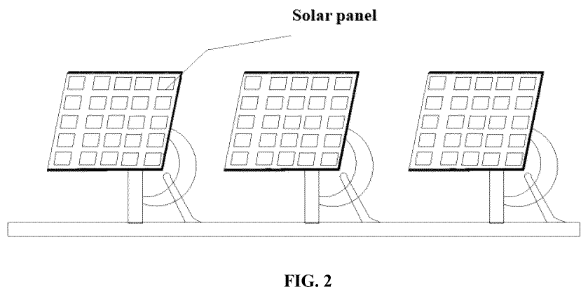

Referring to FIG. 2, the characteristic solar panels selected in the embodiment include solar panels under different illumination conditions.

single-day power generation duration values of the characteristic solar panels are acquired respectively, and a time-of-day average power generation duration value of the solar panels is calculated from the single-day power generation duration values of the characteristic solar panels:

$$Scj = \frac{Sc 1 + Sc 2 + Sc 3 + … + Scp}{p}$$

where Scj is the time-of-day average power generation duration value of the solar panels, Sc1, Sc2, Sc3 . . . Scp are the single-day power generation duration values of the characteristic solar panels respectively, and p is the value of the number of the selected characteristic solar panels and is larger than 0.

The area value of the power generation panel of the power generation cluster, the average generated power value per unit area of the solar panels, and the time-of-day average power generation duration value of the solar panels are defined as the supply basic data.

The fault unit acquires the fault basic data, and includes a voltage sensor, a current sensor, and a temperature sensor.

The fault unit acquires an open circuit voltage value of each solar panel of the photovoltaic power generation cluster in real time through the voltage sensor, acquires a short circuit current value of each solar panel of the photovoltaic power generation cluster in real time through the current sensor, acquires a surface real-time temperature value of each solar panel of the photovoltaic power generation cluster through the temperature sensor respectively, and defines the open circuit voltage value, the short circuit current value, and the surface real-time temperature value of each solar panel as the fault basic data.

It is to be noted here that an open circuit voltage (Voc) of the solar panel refers to a maximum voltage generated by the solar panel in a case of no load connection. It is a voltage output of the solar panel under standard test conditions (STC). The open circuit voltage can be used for evaluating voltage performance of the solar panel.

A short circuit current (Isc) refers to a maximum current generated by the solar panel when a circuit is short-circuited. It is a current output of the solar panel under the standard test conditions. The short circuit current can be used for evaluating current performance of the solar panel.

the demand basic data, the supply basic data, and the fault basic data are defined as the control basic data, and the data acquisition module acquires the control basic data.

More further, the data acquisition module acquires the control basic data, and transmits it to the data analysis module and the data processing module; the data analysis module analyzes the control basic data to obtain the control analysis data; the data analysis module acquires the demand basic data, the supply basic data, and the fault basic data according to the control basic data; and the data analysis module includes a demand analysis unit, a supply analysis unit, and a fault analysis unit.

The data stored in the database further includes an open circuit benchmark voltage value, a short circuit benchmark current value, and a surface benchmark temperature value of the solar panel, and an open circuit voltage fault error value, a short circuit current fault error value, and a surface temperature fault error value of the solar panel.

the demand analysis unit analyzes the demand basic data, specifically, acquires the average daily benchmark electricity consumption of the electricity consumption units, the electricity consumption unit amount, and the daily average temperature value according to the demand basic data, and calculates the electricity demand from the average daily benchmark electricity consumption of the electricity consumption units, the electricity consumption unit amount, and the daily average temperature value through an electricity demand calculation formula:

$$Xd = Jp * Ds * 1 + \vert Tp - 25 \vert$$

where Xd is the electricity demand, Jp is the average daily benchmark electricity consumption of the electricity consumption units, Ds is the electricity consumption unit amount, Tp is the daily average temperature value, and 25° C. is set as a benchmark temperature value.

the supply analysis unit analyzes the supply basic data, acquires the area value of the power generation panel of the power generation cluster, the average generated power value per unit area of the solar panels, and the time-of-day average power generation duration value of the solar panels according to the supply basic data, and calculates the theoretical power generation supply from the area value of the power generation panel of the power generation cluster, the average generated power value per unit area of the solar panels, and the time-of-day average power generation duration value of the solar panels:

$$Fd = Mj * Dw * Scj$$

where Fd is the theoretical power generation supply, Mj is the area value of the power generation panel of the power generation cluster, Dw is the average generated power value per unit area of the solar panels, and Scj is the time-of-day average power generation duration value of the solar panels.

The fault analysis unit analyzes the fault basic data to obtain real-time fault data.

the electricity demand, the theoretical power generation supply, and the real-time fault data are defined as the control analysis data, and the data analysis module acquires the control analysis data.

It is further to be noted that the data stored in the database further includes an open circuit benchmark voltage value, a short circuit benchmark current value, and a surface benchmark temperature value of the solar panel, and an open circuit voltage fault error value, a short circuit current fault error value, and a surface temperature fault error value of the solar panel.

The analyzing the fault basic data by the fault analysis unit includes: acquiring the open circuit voltage value, the short circuit current value, and the surface real-time temperature value of each solar panel according to the fault basic data;
acquiring the open circuit benchmark voltage value, the short circuit benchmark current value, and the surface benchmark temperature value of the solar panel according to the database;
calculating a fault judgment reference value of the solar panel from the open circuit voltage value, the short circuit current value, and the surface real-time temperature value of the solar panel, and the open circuit benchmark voltage value, the short circuit benchmark current value, and the surface benchmark temperature value of the solar panel,

$$Tp = \vert Vk - VKj \vert * \vert Id - Idj \vert + \vert Bw - Bwj \vert * a 1$$

where Tp is the fault judgment reference value of the solar panel, Vk is the open circuit voltage value, Id is the short circuit current value, Bw is the surface real-time temperature value, Vkj is the open circuit benchmark voltage value, the Idj is the short circuit benchmark current value, Bwj is the surface benchmark temperature value, and a1 is a set proportionality coefficient and is larger than 0.

acquiring the open circuit voltage fault error value, the short circuit current fault error value, and the surface temperature fault error value of the solar panel through the database respectively, and calculating a fault judgment reference threshold of the solar panel from the open circuit voltage fault error value, the short circuit current fault error value, and the surface temperature fault error value of the solar panel for fault judgment on the solar panel:

$$Tp 1 = Vk 1 * Id 1 + Bw 1 * a 1$$

where Tp1 is the fault judgment reference threshold of the solar panel, Vk1 is the open circuit voltage fault error value, Id1 is the short circuit current fault error value, Bw1 is the surface temperature fault error value, and a1 is the set proportionality coefficient and is larger than 0;
judging the solar panel as a faulty solar panel if Tp≥Tp1;
judging the solar panel as a normal solar panel if Tp1>Tp;
obtaining a real-time area value of the faulty solar panel through real-time area statistics on the normal solar panel; and
defining the real-time area value of the faulty solar panel as the real-time fault data.

Further, the data processing module includes: obtaining supply and demand control data by processing the control analysis data, and the data processing module acquires the electricity demand, the theoretical power generation supply, and the real-time fault data according to the control analysis data.

The data processing module includes a supply processing unit and a supply and demand balancing unit.

The supply processing unit acquires an actual power generation supply, specifically, acquires the theoretical power generation supply according to the control analysis data, acquires a real-time area value of the faulty solar panel according to the real-time fault data, and acquires the average generated power value per unit area of the solar panels and the time-of-day average power generation duration value of the solar panels according to the control basic data,
calculates the actual power generation supply from the theoretical power generation supply, the real-time area value of the faulty solar panel, the average generated power value per unit area of the solar panels, and the time-of-day average power generation duration value of the solar panels through an actual power generation supply calculation formula:

$$Sg = Fd - ( Gb * Dw * Scj )$$

where Sg is the actual power generation supply, Fd is the theoretical power generation supply, Dw is the average generated power value per unit area of the solar panels, Scj is the time-of-day average power generation duration value of the solar panels, and Gb is the real-time area value of the faulty solar panel.

the supply and demand balancing unit acquires the supply and demand balance reference value, specifically, acquires the actual power generation supply and the electricity demand respectively, and calculates the supply and demand balance reference value from the actual power generation supply and the electricity demand through a supply and demand balance reference value calculation formula:

$$Ph = \frac{Xd}{Sg}$$

where Ph is the supply and demand balance reference value, Xd is the electricity demand, and Sg is the actual power generation supply.

the data processing module acquires the supply and demand balance reference value, and transmits the supply and demand balance reference value to the intelligent control module.

It is further to be noted that the intelligent control module includes: setting a first control interval in response to the supply and demand balance reference value Ph larger than 1 and the electricity demand larger than the actual power generation supply at this time;
setting a second control interval in response to the supply and demand balance reference value Ph equal to 1 and the electricity demand equal to the actual power generation supply at this time; and
setting a third control interval in response to the supply and demand balance reference value Ph smaller than 1 and the electricity demand smaller than the actual power generation supply at this time.

Aiming to the first control interval, the intelligent control system is switched to an efficient working mode, the photovoltaic power generation cluster increases a generated power of the photovoltaic power generation cluster through a cooperative control system, temporarily supplies stored electric energy to an electricity consumption unit,: increases an inclination angle of a photovoltaic cell panel, increases a reception quantity of solar radiation, improves power generation efficiency of a photovoltaic cell, and optimizes a working point of the photovoltaic cell through a maximum power point tracking algorithm, to increase a generated power of a single working point.

Aiming to the second control interval, the photovoltaic power generation cluster maintains the current generated power of the photovoltaic power generation cluster through the cooperative control system.

aiming to the third control interval, the intelligent control system is switched to a low power consumption working mode, the photovoltaic power generation cluster lowers the generated power of the photovoltaic power generation cluster through the cooperative control system, stores excess electric energy, reduces the inclination angle of the photovoltaic cell panel and a reception area of solar radiation, and lowers the generated power.

In the embodiment, a communication protocol of the cooperative control system satisfies an MQTT protocol.

It should be noted that the above embodiments are only intended to illustrate the technical solution of the present invention and not to limit it. Although the preferred embodiments have been described in detail, those skilled in the art should understand that modifications or equivalent substitutions may be made to the technical solution of the present invention without departing from its essence and scope, which are all within the scope of the claims of the present invention.

### Embodiment 2

An embodiment of the present invention provides an intelligent control system for a distributed photovoltaic power generation cluster. In order to verify the beneficial effects of the present invention, scientific demonstration is performed through an experiment.

An electricity consumption unit amount in a corresponding power supply region of the photovoltaic power generation cluster and an area value of a power generation panel are extracted from the database. m electricity consumption units are randomly selected as samples for recording the daily benchmark electricity consumptions; and n characteristic time points are selected for recording temperature values.

An electricity demand and a theoretical power generation supply are calculated by using the collected data, and real-time fault data is obtained by analyzing fault data; an actual power generation supply is calculated in combination with the supply and demand data, and a supply and demand balance reference value is obtained through a supply and demand balance calculation formula; and the photovoltaic power generation cluster is intelligently controlled (including an efficient working mode, maintaining a current power generation mode, and a low power consumption working mode) according to the supply and demand balance reference value.

The effect of the intelligent control system for the distributed photovoltaic power generation cluster is analyzed, as shown in the following table:

TABLE 1

| | | | | | | | Supply |
|---|---|---|---|---|---|---|---|
| | | | | | | | and |
| | Electricity | Area of | Daily | | Theoretical | Actual | demand |
| | consumption | power | benchmark | Daily | power | power | balance |
| | unit | generation | electricity | average | generation | generation | reference |
| Test object | amount | panel | consumption | temperature | supply | supply | value |
| Power supply | 120 | 1000 m² | 2000 kWh | 25° C. | 2500 kWh | 2400 kWh | 1.2 |
| region 1 | | | | | | | |
| Power supply | 150 | 1200 m² | 2200 kWh | 24° C. | 2700 kWh | 2600 kWh | 1.1 |
| region 2 | | | | | | | |
| Power supply | 90 | 800 m² | 1800 kWh | 26° C. | 2000 kWh | 1900 kWh | 1.05 |
| region 3 | | | | | | | |
| Power supply | 130 | 1100 m² | 2100 kWh | 23° C. | 2400 kWh | 2300 kWh | 1.15 |
| region 4 | | | | | | | |

It can be seen from Table 1 that the actual power generation supply after intelligent control slightly drops compared with the theoretical power generation supply, which is mainly due to existence of real-time fault data. However, the supply and demand balance reference value is generally larger than 1, which indicates that in most cases, an actual generated power can meet the demand for electricity.

Compared with the traditional photovoltaic power generation system, the intelligent control system in the present invention can more effectively manage a balance between the supply and the demand, especially during a peak period of demand. For example, in the power supply region 1, although the actual power generation supply is slightly lower than a theoretical value, the supply and demand balance reference value is 1.2, which indicates that the system can still effectively meet the demand for the electricity.

In addition, adaptability of the system under temperature changes and different electricity demand modes is also reflected. For example, in a power supply region 3, although the daily average temperature is high, a gap between the actual power generation supply and the theoretical value is small, which shows stability of the system under a high temperature condition.

It should be noted that the above embodiments are only intended to illustrate the technical solution of the present invention and not to limit it. Although the preferred embodiments have been described in detail, those skilled in the art should understand that modifications or equivalent substitutions may be made to the technical solution of the present invention without departing from its essence and scope, which are all within the scope of the claims of the present invention.

### Embodiment 3

A third embodiment of the present invention is different from the front two embodiments in that:

If a function is implemented in a form of a software functional unit, and sold or used as an independent product, the function may be stored in a computer-readable storage medium. Based on this understanding, the technical solution of the present invention essentially or a part that contributes to the prior art; or part of the technical solution may be embodied in a form of a software product; and the computer software product is stored in a storage medium and includes a plurality of instructions which are used to enable a computer device (which may be a personal computer, a server, or a network device, etc.) to execute all or part of the steps of the methods described in the various embodiments of the present invention. The storage medium includes: a USB flash disk, a mobile hard disk, a read-only memory (ROM), a random access memory (RAM), a magnetic disk or an optical disk and another medium that can store program codes.

Logics and/or steps expressed in the flow chart or otherwise described herein, for example, may be considered as a sequence table of executable instructions for implementing logical functions, and may be implemented in any computer-readable medium for use by instruction execution systems, apparatuses, or devices (such as computer-based systems, systems including processors, or other systems that may acquire instructions from the instruction execution systems, the apparatuses, or the devices and execute the instructions), or in a combination manner. For the purposes of this specification, the “computer-readable medium” may be any device that may contain, store, communicate, propagate or transmit a program for use by the instruction execution systems, the apparatuses, or the devices or in a combination manner.

More specific examples of the machine-readable storage medium (non-exhaustive list) may include an electrical connection (an electronic apparatus) with one or more wires, a portable computer disk case (a magnetic apparatus), a random access memory (RAM), a read-only memory (ROM), an erasable programmable read-only memory (EPROM or flash memory), an optical fiber, and a portable compact disk read-only memory (CDROM). In addition, the computer-readable medium may even be paper or other appropriate media on which the program may be printed. It because that the program may be acquired electronically, for example, by optically scanning the paper or other media, followed by editing, interpretation or, if necessary, other appropriate processing ways, and then stored in a computer memory.

It should be understood that each part of the present invention can be achieved by hardware, software, firmware or a combination thereof. In the above implementation, multiple steps or methods can be implemented with the software or the firmware stored in the memory and executed by the appropriate instruction execution system. For example, if they are implemented by the hardware, as in another implementation, they may be implemented by any one of the following technologies well known in the art or their combination: a discrete logic circuit with a logic gate circuit for implementing a logic function of a data signal, a special integrated circuit with an appropriate combinational logic gate circuit, a programmable gate array (PGA), a field programmable gate array (FPGA), etc.

### Embodiment 4

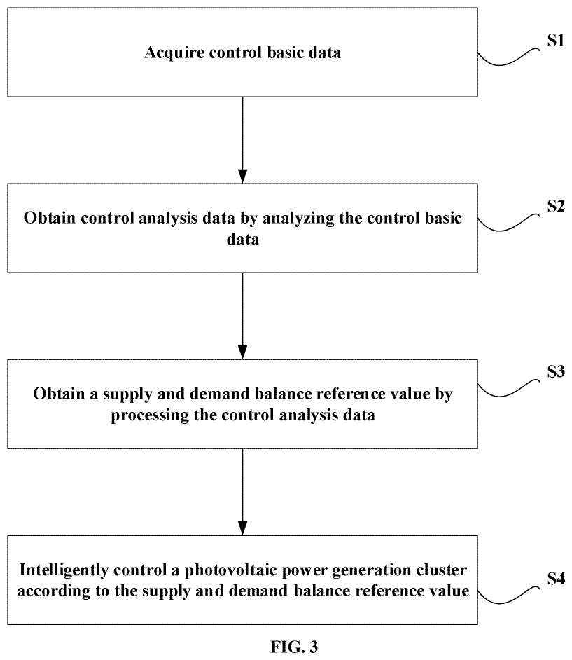

Referring to FIG. 3, showing an embodiment of the present invention, an intelligent control method for a distributed photovoltaic power generation cluster is provided, including:

Step S11: acquiring demand basic data, specifically:
acquiring an electricity consumption unit amount in a corresponding power supply region of the photovoltaic power generation cluster though database;
selecting m electricity consumption units as sample electricity consumption units, and acquiring daily benchmark electricity consumptions of the sample power consumption units through a smart meter; calculating an average daily benchmark electricity consumption of the electricity consumption units from the daily benchmark electricity consumptions of the sample electricity consumption units through an average daily benchmark electricity consumption calculation formula; selecting n characteristic time points, and acquiring temperature values of the n characteristic time points by a weather forecast respectively; calculating a daily average temperature value from the temperature values of the n characteristic time points through an average temperature calculation formula; and defining the average daily benchmark power consumption of the electricity consumption units, the electricity consumption unit amount, and the daily average temperature value as the demand basic data.

Step S12: acquiring supply basic data, specifically:
acquiring an area value of a corresponding power generation panel of the power generation cluster through the database, and randomly selecting p solar panels from the photovoltaic power generation cluster as characteristic solar panels; acquiring real-time generated powers of the characteristic solar panels through an electric power sensor respectively; acquiring area values of the characteristic solar panels through an area measurement instrument respectively; calculating an average generated power value per unit area of the solar panels from the real-time generated powers of the characteristic solar panels and the area values of the characteristic solar panels through a calculation formula of a generated power per unit area; acquiring single-day power generation duration values of the characteristic solar panels respectively, and calculating a time-of-day average power generation duration value of the solar panels from the single-day power generation duration values of the characteristic solar panels through an average single-day power generation duration calculation formula; and defining the area value of the corresponding power generation panel of the power generation cluster, the average generated power value per unit area of the solar panels, and the time-of-day average power generation duration value of the solar panels as the supply basic data.

Step S13: acquiring fault basic data, specifically:

The fault unit acquires an open circuit voltage value of each solar panel of the photovoltaic power generation cluster in real time through the voltage sensor, acquires a short circuit current value of each solar panel of the photovoltaic power generation cluster in real time through the current sensor, acquires a surface real-time temperature value of each solar panel of the photovoltaic power generation cluster through the temperature sensor respectively, and defines the open circuit voltage value, the short circuit current value, and the surface real-time temperature value of each solar panel as the fault basic data.

Step S14: defining the demand basic data, the supply basic data, and the fault basic data as the control basic data.

Step S2: obtaining the control analysis data by analyzing the control basic data.

Step S21: analyzing the demand basic data, specifically:
acquiring the average daily benchmark electricity consumption of the electricity consumption units, the electricity consumption unit amount, and the daily average temperature value according to the demand basic data; and calculating the electricity demand from the average daily benchmark electricity consumption of the electricity consumption units, the electricity consumption unit amount, and the daily average temperature value through an electricity demand calculation formula.

Step S22: analyzing the supply basic data, specifically:
acquiring the area value of the corresponding power generation panel of the power generation cluster, the average generated power value per unit area of the solar panels, and the time-of-day average power generation duration value of the solar panels according to the supply basic data; and calculating the theoretical power generation supply from the area value of the corresponding power generation panel of the power generation cluster, the average generated power value per unit area of the solar panels, and the time-of-day average power generation duration value of the solar panels through a theoretical power generation supply calculation formula.

Step S23: analyzing the fault basic data, specifically:
acquiring an open circuit benchmark voltage value, a short circuit benchmark current value, and a surface benchmark temperature value of each solar panel according to the fault basic data; acquiring an open circuit benchmark voltage value, a short circuit benchmark current value, and a surface benchmark temperature value of the solar panel according to the database; calculating a fault judgment reference value of the solar panel from the open circuit voltage value, the short circuit current value, and the surface real-time temperature value of the solar panel, and the open circuit benchmark voltage value, the short circuit benchmark current value, and the surface benchmark temperature value of the solar panel through a calculation formula of the fault judgment reference value of the solar panel; acquiring an open circuit voltage fault error value, a short circuit current fault error value, and a surface temperature fault error value of the solar panel through the database respectively; calculating a fault judgment reference threshold of the solar panel from the open circuit voltage fault error value, the short circuit current fault error value, and the surface temperature fault error value of the solar panel through a calculation formula of the fault judgment reference threshold of the solar panel; and judging a fault of the solar panel according to the fault judgment reference value of the solar panel and the fault judgment reference threshold of the solar panel, specifically:
judging the solar panel as a faulty solar panel if Tp≥Tp1;
judging the solar panel as a normal solar panel if Tp1>Tp; and
obtaining a real-time area value of the faulty solar panel through real-time area statistics on the normal solar panel; and defining the real-time area value of the faulty solar panel as real-time fault data.

Step S24: defining the electricity demand, the theoretical power generation supply, and the real-time fault data as the control analysis data.

Step S3: obtaining the supply and demand control data by processing the control analysis data.

Step S31: acquiring an actual power generation supply, specifically:
acquiring the theoretical power generation supply according to the control analysis data, acquiring a real-time area value of the faulty solar panel according to the real-time fault data, and acquiring the average generated power value per unit area of the solar panels and the time-of-day average power generation duration value of the solar panels according to the control basic data; and
calculating the actual power generation supply from the theoretical power generation supply, the real-time area value of the faulty solar panel, the average generated power value per unit area of the solar panels, and the time-of-day average power generation duration value of the solar panels through an actual power generation supply calculation formula.

Step S32: acquiring a supply and demand balance reference value, specifically:
acquiring the actual power generation supply and the electricity demand respectively; and
calculating the supply and demand balance reference value from the actual power generation supply and the electricity demand through a supply and demand balance reference value calculation formula.

Step S4: intelligently controlling a photovoltaic power generation cluster, specifically:
dividing control intervals according to the supply and demand balance reference value;
setting a first control interval in response to Ph larger than 1 and the electricity demand larger than the actual power generation supply at this time, setting a second control interval in response to Ph equal to 1 and the electricity demand equal to the actual power generation supply at this time, and
setting a third control interval in response to Ph smaller than 1 and the electricity demand smaller than the actual power generation supply at this time; and
performing intelligent control according to the control intervals, where
aiming to the first control interval, the photovoltaic power generation cluster increases a generated power of the photovoltaic power generation cluster through a cooperative control system, and temporarily supplies stored electric energy to an electricity consumption unit;

Aiming to the second control interval, the photovoltaic power generation cluster maintains the current generated power of the photovoltaic power generation cluster through the cooperative control system.

aiming to the third control interval, the photovoltaic power generation cluster lowers the generated power of the photovoltaic power generation cluster through the cooperative control system, and stores excess electric energy.

A maximum power point tracking algorithm includes: optimizing a working point of the photovoltaic cell, with a specific model as follows:

$${P}_{opt} = {\int }_{{θ}_{min}}^{{θ}_{max}} ( {I}_{SC} \cdot ( 1 - exp ( - \frac{{I}_{pgc}}{{I}_{SC}} ) \cdot \frac{{P}_{mpp} ( θ )}{{\sum }_{i = 1}^{N} {P}_{mpp , i} ( θ )} ) d θ$$

wherein Pₒₚₜ is a maximum generated power of the photovoltaic cell panel subjected to optimization with the maximum power point tracking algorithm, θₘᵢₙ and θₘₐₓ are a maximum value and a minimum value of the inclination angle of the cell panel respectively, I_{SC} is a short circuit current of the cell panel, I_{pgc} is a photogenerated current, Pₘₚₚ(θ) is a power at a maximum power point in a case of the inclination angle being θ, N is a total amount of the photovoltaic cell panels, and P_{mpp,i}(θ) is a power at a maximum power point of the ith cell panel in a case of the inclination angle being θ;
if Pₒₚₜ is close to a maximum value of Pₘₚₚ(θ), the photovoltaic cell panel achieves an optimal power generation state after optimization with the maximum power point tracking algorithm; if Pₒₚₜ is close to 0, the power generation efficiency of the photovoltaic cell panel is very low, which is due to an improper inclination angle of the cell panel; a proper inclination angle of the cell panel is calculated with consideration of influences of the inclination angle and an azimuth angle on the power generation efficiency:

$${α}_{opt} ( t ) = arctan ( \frac{sin ( θ ( t ) )}{cos ( θ ( t ) ) \times sin ( β - φ ( t ) )} )$$

an output power of the maximum power point tracking (MPPT) algorithm with consideration of influences of the MPPT algorithm on the power generation efficiency is expressed as follows:

$${f}_{MPPT} ( {P}_{PV} ) = {P}_{PV} \times ( 1 - exp ( - \frac{{P}_{PV}}{{P}_{PV , max}} ) )$$

$${P}_{PV} ( t ) = {I}_{PV} ( t ) \times {V}_{PV} ( t )$$

the proper inclination angle of the cell panel is calculated after optimization:

$${P}_{PV , opt} ( t ) = {f}_{MPPT} ( {I}_{PV} ( t ) \times {V}_{PV} ( t ) )$$

$${α}_{opt} ( t ) = \frac{{\int }_{0}^{24} {P}_{PV , opt} ( t ) dt}{{\int }_{0}^{24} G ( t ) d t}$$

Wherein I_{PV}(t) represents a current of the photovoltaic cell panel at time t, V_{PV}(t) represents a voltage of the photovoltaic cell panel at time t, P_{PV}(t) represents a power of the photovoltaic cell panel at time t, αₒₚₜ represents an inclination angle between the photovoltaic cell panel and the ground, β represents the azimuth angle of the photovoltaic cell panel, θ(t) represents an altitude angle of the sun, φ(t) represents an azimuth angle of the sun, G(t) represents solar radiation intensity, f_{MPPT}(P_{PV}) represents the output power of the maximum power point tracking algorithm, and P_{PV,max} is the power of the photovoltaic cell panel at the maximum power point.

It should be noted that the above embodiments are only intended to illustrate the technical solution of the present invention and not to limit it. Although the preferred embodiments have been described in detail, those skilled in the art should understand that modifications or equivalent substitutions may be made to the technical solution of the present invention without departing from its essence and scope, which are all within the scope of the claims of the present invention.

What is claimed is:

1. An intelligent control system for a distributed photovoltaic power generation cluster, comprising:
a data acquisition module, used for acquiring demand basic data, supply basic data, and fault basic data respectively to comprehensively obtain control basic data;
a data analysis module, used for analyzing the control basic data to obtain an electricity demand, a theoretical power generation supply, and real-time fault data, and defining the electricity demand, the theoretical power generation supply, and the real-time fault data as control analysis data;
a data processing module, used for processing the control analysis data to obtain a supply and demand balance reference value; and
an intelligent control module, used for intelligently controlling the photovoltaic power generation cluster according to the supply and demand balance reference value.

2. The intelligent control system for the distributed photovoltaic power generation cluster according to claim 1, wherein the data acquisition module comprises: data stored in a database, comprising an electricity consumption unit amount in a corresponding power supply region of the photovoltaic power generation cluster and an area value of a corresponding power generation panel of the photovoltaic power generation cluster;
the data acquisition module comprises a demand unit, a supply unit, and a fault unit;
the demand unit acquires the demand basic data, specifically, acquires the electricity consumption unit amount in the corresponding power supply region of the photovoltaic power generation cluster and the area value of the corresponding power generation panel of the photovoltaic power generation cluster through the database, selects m electricity consumption units as sample electricity consumption units, acquires daily benchmark electricity consumptions of the sample power consumption units through a smart meter respectively, and calculates an average daily benchmark electricity consumption of the electricity consumption units based on the daily benchmark electricity consumptions of the sample electricity consumption units:
$$Jp = \frac{J 1 + J 2 + J 3 + … + Jm}{m}$$
wherein Jp is the average daily benchmark electricity consumption of the electricity consumption units, and J1, J2, J3 . . . Jm are the daily benchmark electricity consumptions of the m sample electricity consumption units respectively;
n characteristic time points are selected, and temperature values of the n characteristic time points are acquired by a weather forecast respectively, and a daily average temperature value is calculated from the temperature values of the n characteristic time points through an average temperature calculation formula:
$$Tp = \frac{T 1 + T 2 + … + Tn}{n}$$
wherein T1, T2, T3 . . . Tn are the temperature values of the n characteristic time points respectively, Tp is the daily average temperature value, and n is larger than 0;
the average daily benchmark electricity consumption of the electricity consumption units, the electricity consumption unit amount, and the daily average temperature value are defined as the demand basic data;
the supply unit acquires the supply basic data, acquires the area value of the power generation panel of the power generation cluster through the database, randomly selects p solar panels from the photovoltaic power generation cluster as characteristic solar panels, acquires real-time generated powers of the characteristic solar panels through an electric power sensor respectively, acquires area values of the characteristic solar panels through an area measurement instrument respectively, and calculates an average generated power value per unit area of the solar panels from the real-time generated powers of the characteristic solar panels and the area values of the characteristic solar panels through a calculation formula of a generated power per unit area:
$$Dw = \frac{\frac{W 1}{S 1} + \frac{W 2}{S 2} + \frac{W 3}{S 3} + … + \frac{W p}{S p}}{p}$$
wherein W1, W2, W3 . . . Wp are the real-time generated powers of the characteristic solar panels respectively, S1, S2, S3 . . . Sn are area values of the characteristic solar panels respectively, and p is a value of a number of the selected characteristic solar panels and is larger than 0;
single-day power generation duration values of the characteristic solar panels are acquired respectively, and a time-of-day average power generation duration value of the solar panels is calculated from the single-day power generation duration values of the characteristic solar panels:
$$Scj = \frac{Sc 1 + Sc 2 + Sc 3 + … + Scp}{p}$$
wherein Scj is the time-of-day average power generation duration value of the solar panels, Sc1, Sc2, Sc3 . . . Scp are the single-day power generation duration values of the characteristic solar panels respectively, and p is the value of the number of the selected characteristic solar panels and is larger than 0;
the area value of the power generation panel of the power generation cluster, the average generated power value per unit area of the solar panels, and the time-of-day average power generation duration value of the solar panels are defined as the supply basic data;
the fault unit acquires the fault basic data, specifically, acquires an open circuit voltage value of each solar panel of the photovoltaic power generation cluster in real time through a voltage sensor, acquires a short circuit current value of each solar panel of the photovoltaic power generation cluster in real time through a current sensor, acquires a surface real-time temperature value of each solar panel of the photovoltaic power generation cluster through a temperature sensor respectively, and defines the open circuit voltage value, the short circuit current value, and the surface real-time temperature value of each solar panel as the fault basic data; and
the demand basic data, the supply basic data, and the fault basic data are defined as the control basic data, and the data acquisition module acquires the control basic data.

3. The intelligent control system for the distributed photovoltaic power generation cluster according to claim 2, wherein the data analysis module comprises obtaining the control analysis data by analyzing the control basic data, and comprises a demand analysis unit, a supply analysis unit, and a fault analysis unit;
the data stored in the database further comprises an open circuit benchmark voltage value, a short circuit benchmark current value, and a surface benchmark temperature value of the solar panel, and an open circuit voltage fault error value, a short circuit current fault error value, and a surface temperature fault error value of the solar panel;
the demand analysis unit analyzes the demand basic data, specifically, acquires the average daily benchmark electricity consumption of the electricity consumption units, the electricity consumption unit amount, and the daily average temperature value according to the demand basic data, and calculates the electricity demand from the average daily benchmark electricity consumption of the electricity consumption units, the electricity consumption unit amount, and the daily average temperature value through an electricity demand calculation formula:
$$Xd = Jp * DS * 1 + \vert Tp - 25 \vert$$
wherein Xd is the electricity demand, Jp is the average daily benchmark electricity consumption of the electricity consumption units, Ds is the electricity consumption unit amount, and Tp is the daily average temperature value;
the supply analysis unit analyzes the supply basic data, acquires the area value of the power generation panel of the power generation cluster, the average generated power value per unit area of the solar panels, and the time-of-day average power generation duration value of the solar panels according to the supply basic data, and calculates the theoretical power generation supply from the area value of the power generation panel of the power generation cluster, the average generated power value per unit area of the solar panels, and the time-of-day average power generation duration value of the solar panels:
$$Fd = Mj * Dw * Scj$$
wherein Fd is the theoretical power generation supply, Mj is the area value of the power generation panel of the power generation cluster, Dw is the average generated power value per unit area of the solar panels, and Scj is the time-of-day average power generation duration value of the solar panels;
the fault analysis unit analyzes the fault basic data to obtain real-time fault data; and
the electricity demand, the theoretical power generation supply, and the real-time fault data are defined as the control analysis data, and the data analysis module acquires the control analysis data.

4. The intelligent control system for the distributed photovoltaic power generation cluster according to claim 3, wherein the analyzing the fault basic data by the fault analysis unit comprises: acquiring the open circuit voltage value, the short circuit current value, and the surface real-time temperature value of each solar panel according to the fault basic data;
acquiring the open circuit benchmark voltage value, the short circuit benchmark current value, and the surface benchmark temperature value of the solar panel according to the database;
calculating a fault judgment reference value of the solar panel from the open circuit voltage value, the short circuit current value, and the surface real-time temperature value of the solar panel, and the open circuit benchmark voltage value, the short circuit benchmark current value, and the surface benchmark temperature value of the solar panel,
$$Tp = \vert Vk - VKj \vert * \vert Id - Idj \vert + \vert Bw - Bwj \vert * a 1$$
wherein Tp is the fault judgment reference value of the solar panel, Vk is the open circuit voltage value, Id is the short circuit current value, Bw is the surface real-time temperature value, Vkj is the open circuit benchmark voltage value, the Idj is the short circuit benchmark current value, Bwj is the surface benchmark temperature value, and a1 is a set proportionality coefficient and is larger than 0;
acquiring the open circuit voltage fault error value, the short circuit current fault error value, and the surface temperature fault error value of the solar panel through the database respectively, and calculating a fault judgment reference threshold of the solar panel from the open circuit voltage fault error value, the short circuit current fault error value, and the surface temperature fault error value of the solar panel for fault judgment on the solar panel:
$$Tp 1 = Vk 1 * Id 1 + Bw 1 * a 1$$
wherein Tp1 is the fault judgment reference threshold of the solar panel, Vk1 is the open circuit voltage fault error value, Id1 is the short circuit current fault error value, Bw1 is the surface temperature fault error value, and a1 is the set proportionality coefficient and is larger than 0;
judging the solar panel as a faulty solar panel if Tp≥Tp1;
judging the solar panel as a normal solar panel if Tp1>Tp;
obtaining a real-time area value of the faulty solar panel through real-time area statistics on the normal solar panel; and
defining the real-time area value of the faulty solar panel as the real-time fault data.

5. The intelligent control system for the distributed photovoltaic power generation cluster according to claim 4, wherein the data processing module comprises: obtaining supply and demand control data by processing the control analysis data, and the data processing module acquires the electricity demand, the theoretical power generation supply, and the real-time fault data according to the control analysis data;
the data processing module comprises a supply processing unit and a supply and demand balancing unit;
the supply processing unit acquires an actual power generation supply, specifically, acquires the theoretical power generation supply according to the control analysis data, acquires a real-time area value of the faulty solar panel according to the real-time fault data, acquires the average generated power value per unit area of the solar panels and the time-of-day average power generation duration value of the solar panels according to the control basic data, and
calculates the actual power generation supply from the theoretical power generation supply, the real-time area value of the faulty solar panel, the average generated power value per unit area of the solar panels, and the time-of-day average power generation duration value of the solar panels through an actual power generation supply calculation formula:
$$Sg = Fd - ( Gb * Dw * Scj )$$
wherein Sg is the actual power generation supply, Fd is the theoretical power generation supply, Dw is the average generated power value per unit area of the solar panels, Scj is the time-of-day average power generation duration value of the solar panels, and Gb is the real-time area value of the faulty solar panel;
the supply and demand balancing unit acquires the supply and demand balance reference value, specifically, acquires the actual power generation supply and the electricity demand respectively, and calculates the supply and demand balance reference value according to a supply and demand balance reference value calculation formula by acquiring the actual power generation supply and the electricity demand:
$$Ph = \frac{Xd}{Sg}$$
wherein Ph is the supply and demand balance reference value, Xd is the electricity demand, and Sg is the actual power generation supply; and
the data processing module acquires the supply and demand balance reference value, and transmits the supply and demand balance reference value to the intelligent control module.

6. The intelligent control system for the distributed photovoltaic power generation cluster according to claim 5, wherein the intelligent control module comprises: setting a first control interval in response to the supply and demand balance reference value Ph larger than 1 and the electricity demand larger than the actual power generation supply at this time;
setting a second control interval in response to the supply and demand balance reference value Ph equal to 1 and the electricity demand equal to the actual power generation supply at this time; and
setting a third control interval in response to the supply and demand balance reference value Ph smaller than 1 and the electricity demand smaller than the actual power generation supply at this time, wherein
aiming to the first control interval, the intelligent control system is switched to an efficient working mode, the photovoltaic power generation cluster increases a generated power of the photovoltaic power generation cluster through a cooperative control system, temporarily supplies stored electric energy to an electricity consumption unit, increases an inclination angle of a photovoltaic cell panel, increases a reception quantity of solar radiation, improves power generation efficiency of a photovoltaic cell, and optimizes a working point of the photovoltaic cell through a maximum power point tracking algorithm, to increase a generated power of a single working point;
aiming to the second control interval, the photovoltaic power generation cluster maintains the current generated power of the photovoltaic power generation cluster through the cooperative control system; and
aiming to the third control interval, the intelligent control system is switched to a low power consumption working mode, the photovoltaic power generation cluster lowers the generated power of the photovoltaic power generation cluster through the cooperative control system, stores excess electric energy, reduces the inclination angle of the photovoltaic cell panel and a reception area of solar radiation, and lowers the generated power.

7. A method using the intelligent control system for the distributed photovoltaic power generation cluster according to claim 1, comprising:
acquiring the control basic data;
obtaining the control analysis data by analyzing the control basic data;
obtaining the supply and demand balance reference value by processing the control analysis data; and
intelligently controlling the photovoltaic power generation cluster according to the supply and demand balance reference value, and optimizing the working point of the photovoltaic cell through the maximum power point tracking algorithm.

8. The intelligent control method for the distributed photovoltaic power generation cluster according to claim 7, wherein the maximum power point tracking algorithm comprises: optimizing the working point of the photovoltaic cell, with a specific model as follows:
$${P}_{opt} = {\int }_{{θ}_{min}}^{{θ}_{max}} ( {I}_{SC} \cdot ( 1 - exp ( - \frac{{I}_{pgc}}{{I}_{SC}} ) \cdot \frac{{P}_{mpp} ( θ )}{{\sum }_{i = 1}^{N} {P}_{mpp , i} ( θ )} ) d θ$$
wherein Pₒₚₜ is a maximum generated power of the photovoltaic cell panel subjected to optimization with the maximum power point tracking algorithm, θₘᵢₙ and θₘₐₓ are a maximum value and a minimum value of the inclination angle of the cell panel respectively, I_{SC} is a short circuit current of the cell panel, I_{pgc} is a photogenerated current, Pₘₚₚ(θ) is a power at a maximum power point in a case of the inclination angle being θ, N is a total amount of the photovoltaic cell panels, and P_{mpp,i}(θ) is a power at a maximum power point of the i^{th} cell panel in a case of the inclination angle being θ;
if Pₒₚₜ is close to a maximum value of Pₘₚₚ(θ), the photovoltaic cell panel achieves an optimal power generation state after optimization with the maximum power point tracking algorithm; if Pₒₚₜ is close to 0, the power generation efficiency of the photovoltaic cell panel is very low, which is due to an improper inclination angle of the cell panel; a proper inclination angle of the cell panel is calculated with consideration of influences of the inclination angle and an azimuth angle on the power generation efficiency:
$${α}_{opt} ( t ) = arctan ( \frac{sin ( θ ( t ) )}{cos ( θ ( t ) ) \times sin ( β - φ ( t ) )} )$$
an output power of the maximum power point tracking (MPPT) algorithm with consideration of influences of the MPPT algorithm on the power generation efficiency is expressed as follows:
$${f}_{MPPT} ( {P}_{PV} ) = {P}_{PV} \times ( 1 - exp ( - \frac{{P}_{PV}}{{P}_{PV , max}} ) )$$
$${P}_{PV} ( t ) = {I}_{PV} ( t ) \times {V}_{PV} ( t )$$
the proper inclination angle of the cell panel is calculated after optimization:
$${P}_{PV , opt} ( t ) = {f}_{MPPT} ( {I}_{PV} ( t ) \times {V}_{PV} ( t ) )$$
$${α}_{opt} ( t ) = \frac{{\int }_{0}^{24} {P}_{PV , opt} ( t ) d t}{{\int }_{0}^{24} G ( t ) d t}$$
wherein I_{PV}(t) represents a current of the photovoltaic cell panel at time t, V_{PV}(t) represents a voltage of the photovoltaic cell panel at time t, P_{PV}(t) represents a power of the photovoltaic cell panel at time t, αₒₚₜ represents an inclination angle between the photovoltaic cell panel and the ground, β represents the azimuth angle of the photovoltaic cell panel, θ(t) represents an altitude angle of the sun, φ(t) represents an azimuth angle of the sun, G(t) represents solar radiation intensity, f_{MPPT}(P_{PV}) represents the output power of the maximum power point tracking algorithm, and P_{PV,max} is the power of the photovoltaic cell panel at the maximum power point.

9. A computer device, comprising a memory in which a computer program is stored and a processor, wherein when the computer program is executed by the processor, the steps of the method according to claim 7 are implemented.

10. A computer-readable storage medium in which a computer program is stored, wherein when the computer program is executed by a processor, the steps of the method according to claim 7 are implemented.
